(19) United States
(12) Patent Application Publication
(10) Pub. No.: US 2019/0211700 A1
(43) Pub. Date: Jul. 11, 2019

(54) REDUCED MASS INTERSHAFT SEAL ASSEMBLY FOR IMPROVED WEAR RATES

(71) Applicant: Rolls-Royce Corporation, Indianapolis, IN (US)

(72) Inventor: John Munson, Indianapolis, IN (US)

(73) Assignee: Rolls-Royce Corporation, Indianapolis, IN (US)

(21) Appl. No.: 15/866,034

(22) Filed: Jan. 9, 2018

(51) Int. Cl. F01D 11/00; F02C 7/28; F16J 15/3284

(52) U.S. Cl. CPC F01D 11/003; F02C 7/28; F16J 15/34; F05D 2240/58; F16J 15/3284

(57) ABSTRACT

A seal assembly for sealing a high pressure fluid cavity from a low pressure fluid cavity, the cavities at least partially disposed between a hollow rotating shaft and a co-axial rotating shaft at least partially disposed within the hollow rotating shaft, is provided. The seal assembly comprises a pair of annular axially-spaced runners and an annular seal ring positioned axially between the runners. The annular seal ring has an axial dimension, a radial dimension, and a radially-outward facing surface frictionally engaged with a surface rotating with the hollow rotating shaft. The cross-sectional area at any point along the circumference of the annular seal ring is less than the product of the axial dimension multiplied by the radial dimension of the annular seal ring at that point along the circumference.

### FIELD OF THE DISCLOSURE

The present disclosure relates generally to turbine machines, and more specifically to intershaft seal assemblies used in gas turbine engines.

### BACKGROUND

Intershaft seals and intershaft seal assemblies may be used to isolate spaces between shafts in turbine engines having co-axial shafts. In one common design, a first shaft connects a fan, a first stage compressor, and a second stage turbine while a second shaft connects a second stage compressor and first stage turbine. The first shaft rotates at a relatively lower speed than the second shaft. The first and second shafts are co-axial and may be either co- or counter-rotational. To be effective, an intershaft seal must therefore isolate spaces between the shafts having potentially high differential rotational speeds, and the spaces may also have a potentially high differential pressure.

Intershaft seals are used in turbine engines which provide energy for a wide range of uses. Examples of turbine engines include turbofan, turbojet, turboshaft, and turboprop engines. As just one example of the wide range of applications such engines are suitable for, gas turbine engines are used to provide propulsion to an aircraft.

A typical gas turbine engine comprises an inlet fan, a compressor, a combustor, a high-pressure turbine, and a low-pressure turbine. As one example of a typical dual-shaft gas turbine engine 50, FIG. 1 illustrates a first shaft 20 which connects a fan 52, first stage compressor 54, and second stage turbine 62. A second shaft 24 is hollow and is concentrically located around first shaft 20 and connects a second stage compressor 56 with a first stage turbine 60. A combustor 58 is disposed between second stage compressor 56 and first stage turbine 60. First shaft 20 is radially inward from second shaft 24 and rotates at a relatively lower speed. Intershaft seal assemblies 10 are used at least at each axial terminus of outer shaft 22 to seal the spaces between the two concentric shafts 24, 20.

One design for an intershaft seal involves the use of a seal ring which is sometimes referred to in the art as a piston ring. FIG. 2 illustrates a seal ring design for a prior art intershaft seal. Intershaft seal assembly 10 comprises a seal ring 12 in contact with an annular retaining arm 14. The seal ring 12 is disposed between a pair of runners 16 (or retaining rings) which are spaced apart by a spacer 18 and coupled to an inner shaft 20. Retaining arm 14 is coupled to a hollow outer shaft 22 and may be held in place by a retention member 24. Inner shaft 20 and outer shaft 22 can be co- or counter-rotational. Seal assembly 10 serves to isolate high pressure fluid cavity 30 from a lower pressure fluid cavity 32.

When inner shaft 20 and outer shaft 22 are not in motion, a slight gap (not shown) is present between seal ring 12 and retaining arm 14. However, once inner shaft 20 begins to rotate the centrifugal force from rotation will move seal ring 12 radially outward and into contact with retaining arm 14. Typically, seal ring 12 is not a full hoop; as a result, seal ring 12 lacks sufficient strength to resist the deflection caused by centrifugal force and tends to deflect radially outward until contacting retaining arm 14.

Seal ring 12 and runners 16 are initially each rotating in the same direction and at the same rotational speed as inner shaft 20. Once seal ring 12 contacts retaining arm 14, seal ring 12 will begin rotating in the same direction and at substantially the same rotational speed as outer shaft 22. This tends to create a large differential velocity between seal ring 12 and runners 16.

FIG. 3 illustrates some of the forces acting on seal ring 12 during operation of the turbine engine (i.e. while inner shaft 20 and outer shaft 22 are rotating). A relatively large centrifugal force (F_{centrifugal}) from rotation of the inner shaft 20 acts on seal ring 12 in a radially outward direction, bringing seal ring 12 into contact with retaining arm 14. An axial differential pressure force (F_{D/P}) acts on seal ring 12 in the vicinity of the pressure boundary in a direction from high pressure fluid cavity 30 to low pressure fluid cavity 32. To form an effective seal, the centrifugal force must be large enough to hold seal ring 12 in contact with retaining arm 14 despite the axial force of differential pressure across the seal ring 12.

Forces caused by relative lateral motion (F_{lateral movement}) between the inner shaft 20 and outer shaft 22 act on seal ring 12 in a direction either axially forward or axially aft. Finally a moment M, sometimes referred to as ring tension, resists radial expansion during rotation of seal ring 12.

The configuration described above with reference to FIGS. 2 and 3 has drawbacks, including excessive heat generation and a high wear rate of seal ring 12. Thus there is a need in the art for an effective intershaft seal assembly which is better suited to resist heat generation and wear of the seal ring.

### SUMMARY

The present application discloses one or more of the features recited in the appended claims and/or the following features which, alone or in any combination, may comprise patentable subject matter.

According to an aspect of the present disclosure, a seal assembly for sealing a high pressure fluid cavity from a low pressure fluid cavity is provided. The cavities are at least partially disposed between a hollow rotating shaft and a co-axial rotating shaft at least partially disposed within the hollow rotating shaft. The seal assembly comprises a pair of annular axially-spaced runners carried by an outer surface of the co-axial rotating shaft, where each of the runners have an axially-facing radially-extending side surface opposing an axially-facing radially-extending side surface of the other runner. The seal assembly further comprises an annular seal ring positioned axially between the opposing side surfaces of the runners, where the annular seal ring has an axial dimension, a radial dimension, and a radially-outward facing surface frictionally engaged with a surface rotating with the hollow rotating shaft. The cross-sectional area at any point along the circumference of the annular seal ring is less than the product of the axial dimension multiplied by the radial dimension of the annular seal ring at that point along the circumference.

In some embodiments the cross-sectional area at any point along the circumference of the annular seal ring is one of I-, T-, O-, or U-shaped. In some embodiments the annular seal ring comprises a member joined at its ends in a butt joint. In some embodiments the annular seal ring comprises a member joined at its ends in a lap joint. In some embodiments the annular seal ring comprises an O-shape cross section having an interior honeycomb. In some embodiments the annular seal ring comprises more than one materials. In some embodiments the more than one materials are combined to form the annular seal ring by additive manufacturing. In some embodiments the interior honeycomb is formed from ceramic. In some embodiments the O-shape is formed from a carbon-based material. In some embodiments the annular seal ring comprises an U-shape cross section having one or more ribs extending axially from one interior side of the U to the other interior side of the U. In some embodiments the ribs comprise ceramic and the U comprises a carbon-based material.

According to another aspect of the present disclosure, a seal assembly for sealing a high pressure fluid cavity from a low pressure fluid cavity is provided. The cavities are at least partially disposed between a hollow rotating shaft and a co-axial rotating shaft at least partially disposed within the hollow rotating shaft. The seal assembly comprises a pair of annular axially-spaced runners carried by an outer surface of the co-axial rotating shaft, where each of the runners has an axially-facing radially-extending side surface opposing an axially-facing radially-extending side surface of the other runner. The seal assembly further comprises an annular seal ring positioned axially between the opposing side surfaces of the runners, where the annular seal ring has a radially-outward facing surface frictionally engaged with a surface rotating with the hollow rotating shaft. The annular ring defines one or more interior channels extending arcuately through at least a portion of the annular ring.

In some embodiments the interior channels are circumferentially segmented. In some embodiments the interior channels extend the full circumference of the seal ring. In some embodiments portions of the seal ring bounding the one or more interior channels comprise a first material and externally-facing portions of the seal ring comprise a second material. In some embodiments the first material is ceramic. In some embodiments the second material is carbon graphite. In some embodiments the first material and the second material are joined to form the annular seal ring by additive manufacturing. In some embodiments the annular seal ring comprises an O-shaped cross section at any point along the circumference of the annular seal ring. In some embodiments the annular seal ring further comprises one or more reinforcing ribs extending through the hollow portion of the O-shaped cross-section.

According to still further aspects of the present disclosure, a method for sealing a high pressure fluid cavity from a low pressure fluid cavity is provided. The cavities are at least partially disposed between a hollow rotating shaft and a co-axial rotating shaft at least partially disposed within the hollow rotating shaft. The method comprises rotating the co-axial rotating shaft that carries a pair of annular axially-spaced runners and an annular seal ring disposed axially between the runners to effect engagement of a radially-outward facing surface of the annular seal ring with a surface of the hollow rotating shaft. The annular seal ring has an axial dimension and a radial dimension, and a cross-sectional area at any point along the circumference of the annular seal ring is less than the product of the axial dimension multiplied by the radial dimension of the annular seal ring at that point along the circumference.

In some embodiments the co-axial rotating shaft is rotated in a first rotational direction and the hollow shaft is rotated in a second rotational direction. In some embodiments the co-axial rotating shaft and the hollow shaft are rotated in the same rotational direction.

### BRIEF DESCRIPTION OF THE DRAWINGS

The following will be apparent from elements of the figures, which are provided for illustrative purposes and are not necessarily to scale.

FIG. 1 is a schematic diagram of a typical dual-shaft gas turbine engine.

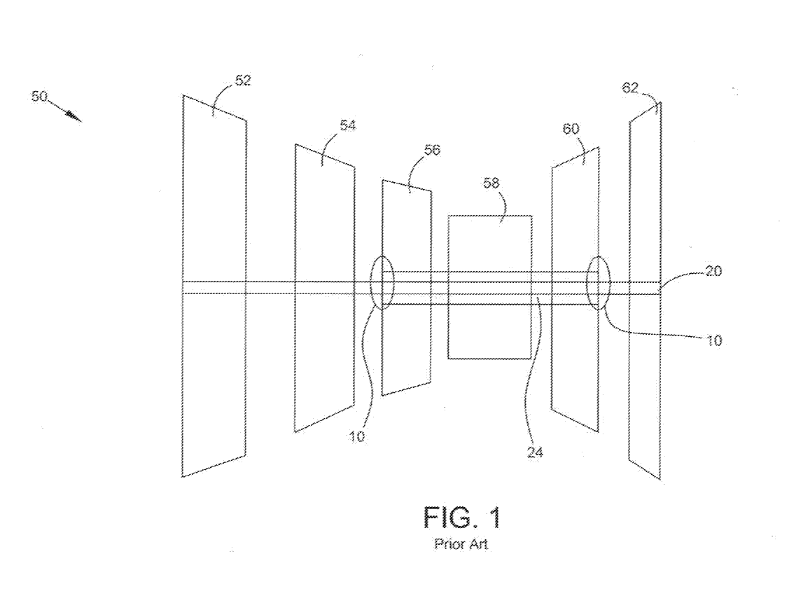

FIG. 2 is a depiction of a prior art intershaft seal assembly.

FIG. 3 is a depiction of some of the forces acting on a seal ring during rotation of the shafts.

FIGS. 4A-4E are cross-sectional views of various embodiments of a seal ring taken at a point along the circumference of the seal ring in accordance with some embodiments of the present disclosure.

FIGS. 5A-5D are cross-sectional views of various embodiments of a seal ring taken at a point along the circumference of the seal ring in accordance with some embodiments of the present disclosure.

FIGS. 6A and 6B are cross-sectional views of various embodiments of a seal ring taken at a point along the circumference of the seal ring in accordance with some embodiments of the present disclosure.

FIGS. 7A and 7B are axial profile views of various embodiments of a seal ring in accordance with some embodiments of the present disclosure.

FIGS. 8A-8F are cross-sectional views of various embodiments of a seal ring taken at a point along the circumference of the seal ring in accordance with some embodiments of the present disclosure.

FIGS. 9A and 9B are partial isometric views of various embodiments of a seal ring in accordance with some embodiments of the present disclosure.

FIG. 10 is a depiction of an intershaft seal assembly having a reduced-mass seal ring in accordance with some embodiments of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

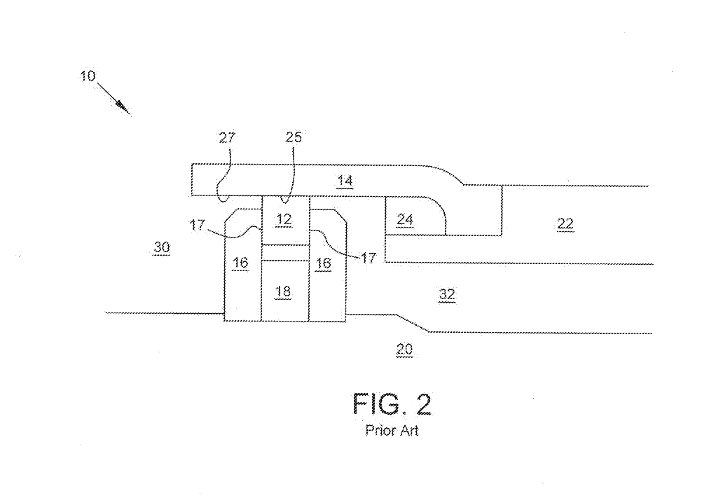

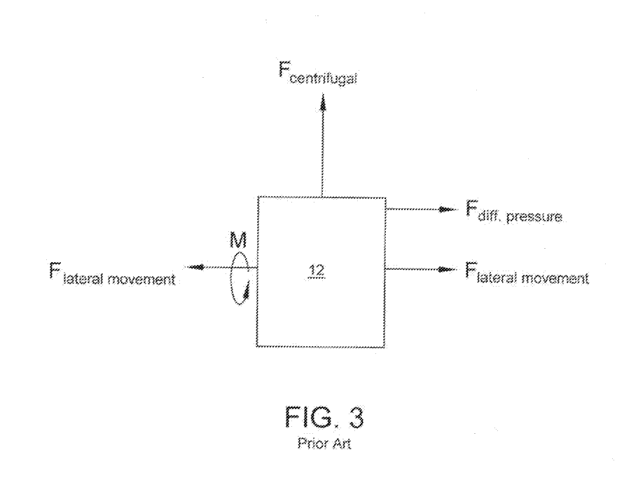

The configuration described above with reference to FIGS. 2 and 3 has drawbacks. Notably, the difference in rotational speeds between inner shaft 20 and outer shaft 22 creates high friction between seal ring 12 (rotating with outer shaft 22) and runners 16 (rotating with inner shaft 20) during transients when the forces caused by relative lateral movement between the shafts overcomes the centrifugal force effecting contact between seal ring 12 and the outer shaft retaining arm 14 thus forcing the seal ring 12 to contact the forward or aft runner 16. This high friction can cause excessive heat generation in the seal assembly 10 as well as a high wear rate of seal ring 12. Excessive heat generation and high wear rates are made worse as shaft speeds increase (resulting in increased centrifugal forces exerted on the seal ring against a sealing surface) and as the relative velocity between the two shafts increases.

The present disclosure is thus directed to seal assemblies 10 and seal rings 12 that reduce friction between the various components of a seal ring assembly 10 and thus reduce heat generation and wear rates. More particularly, the present disclosure is directed to reduced-mass seal rings 71 that, during operation, result in a reduced centrifugal force effecting contact between seal ring 71 and the outer shaft retaining arm 14 thus reducing friction between those elements. Reduced-mass seal rings 71 may also be referred to as seal rings with reduced apparent density.

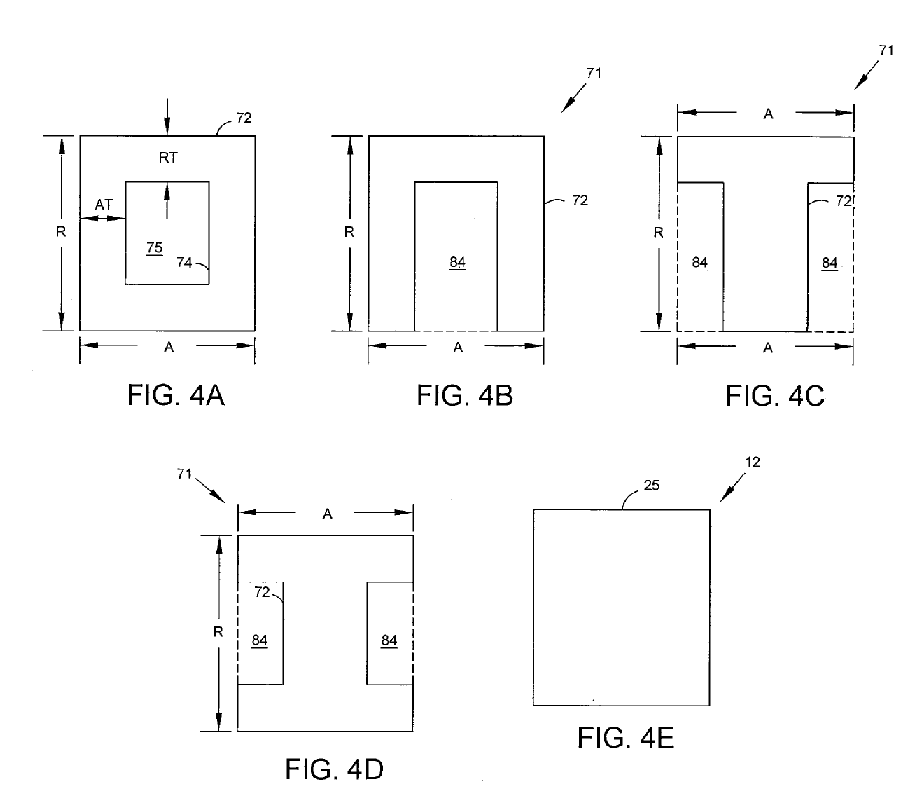

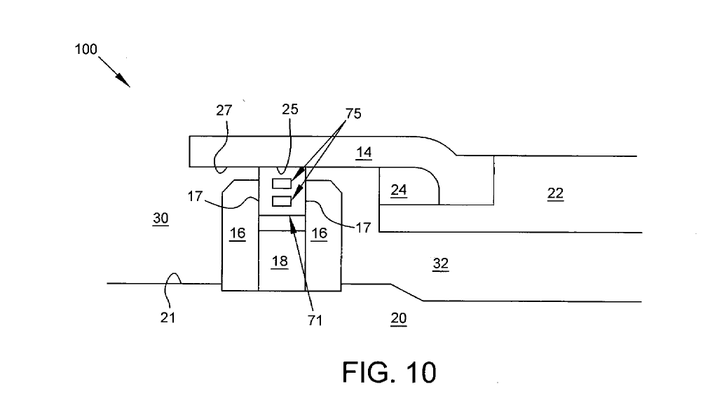

FIGS. 4A through 9B present various views of several embodiments of reduced-mass seal rings 71. FIG. 10 presents a seal ring assembly 10 having a seal ring 71 in accordance with an embodiment of the present disclosure.

As illustrated in FIG. 10, the present disclosure provides for an intershaft seal assembly 10 comprising a reduced-mass seal ring 71 in contact with an annular retaining arm 14. The intershaft seal assembly 10 seals a relatively high pressure fluid cavity 30 from a relatively low pressure fluid cavity 32. The cavities are at least partially disposed between a hollow rotating shaft (outer shaft 22) and a co-axial rotating shaft (inner shaft 20) at least partially disposed within the hollow rotating shaft.

The reduced-mass seal ring 71 is disposed between a pair of annular, axially-spaced runners 16 (or retaining rings) which are spaced apart by a spacer 18 and carried by an outer surface 21 of the inner shaft 20. Each of said runners 16 comprise an axially-facing radially-extending side surface 17 opposing an axially-facing radially-extending side surface 17 of the other runner.

The reduced-mass seal ring 71 may be annular, and is positioned axially between the opposing side surfaces 17 of the runners 16. The reduced-mass seal ring 71 has a radially-outward facing surface 25 that is frictionally engaged with a surface 27 rotating with the outer shaft 22. The reduced-mass seal ring 71 defines one or more interior channels 75 that are described in greater detail below.

Retaining arm 14 is coupled to a hollow outer shaft 22 and may be held in place by a retention member 24. Inner shaft 20 and outer shaft 22 can be co- or counter-rotational. Seal assembly 10 serves to isolate relatively high pressure fluid cavity 30 from relativity lower pressure fluid cavity 32.

When inner shaft 20 and outer shaft 22 are not in motion, a slight gap (not shown) is present between reduced-mass seal ring 71 and retaining arm 14. However, once inner shaft 20 begins to rotate the centrifugal force from rotation will move reduced-mass seal ring 71 radially outward and into contact with retaining arm 14. Typically, reduced-mass seal ring 71 is not a full hoop; as a result, reduced-mass seal ring 71 lacks sufficient strength to resist the deflection caused by centrifugal force and tends to deflect radially outward until contacting retaining arm 14.

Reduced-mass seal ring 71 and runners 16 are initially each rotating in the same direction and at the same rotational speed as inner shaft 20. Once reduced-mass seal ring 71 contacts retaining arm 14, reduced-mass seal ring 71 will begin rotating in the same direction and at substantially the same rotational speed as outer shaft 22.

FIG. 4E presents a cross-sectional view of a seal ring 12 of the prior art (as described above with reference to FIG. 2) at a point along the circumference of the seal ring 12. Seal ring 12 has a generally rectangular cross section and is formed from a solid, uniform material through the cross-section.

FIGS. 4A-4D present embodiments of a reduced-mass seal ring 71 in accordance with the present disclosure. Reduced-mass seal ring 71 may have a cross section, taken at a point along the circumference of the reduced-mass seal ring 71, shaped as one of an 0, a U, a T, or an I as shown in FIGS. 4A, 4B, 4C, and 4D, respectively.

As shown in FIG. 4A, reduced-mass seal rings 71 having an 0 cross-sectional shape have an exterior surface 72 and an interior surface 74. The interior surface 74 defines an interior channel 75. The cross-sectional shape of the seal ring 71 may also include a radial thickness RT, which is the thickness of the seal ring 71 in a radial dimension between the interior surface 74 and exterior surface 72, and an axial thickness AT, which is the thickness of the seal ring 71 in an axial dimension between the interior surface 74 and exterior surface 72.

As shown in FIG. 4B, reduced mass seal rings 71 having a U cross sectional shape have a continuous exterior surface 72 that may partially define a cut-out 84 or indentation that deviates from a standard quadrilateral shape. When positioned in a seal assembly 10, reduced mass seal rings 71 having a U cross sectional shape are typically inverted such that the base of the U shape contacts a surface 27 rotating with the outer shaft 22.

As shown in FIG. 4C, reduced mass seal rings 71 having a T cross sectional shape have a continuous exterior surface 72. The exterior surface 72 may partially define a cut-out 84 or indentation that deviates from a standard quadrilateral shape.

As shown in FIG. 4D, reduced mass seal rings 71 having an I cross sectional shape have a continuous exterior surface 72. The exterior surface 72 may partially define a cut-out 84 or indentation that deviates from a standard quadrilateral shape.

Regardless of the cross-sectional shape, each of the reduced-mass seal rings 71 have an axial dimension A and a radial dimension R. According to embodiments of the present disclosure, a reduced-mass seal ring 71 may have a cross-sectional area at any point along the circumference of the seal ring 71 that is less than the product of the axial dimension A and the radial dimension R at that point along the circumference. In some embodiments, the cross-sectional area at any point along the circumference is less than the cross-sectional area of the standard rectangular cross-sectioned seal ring 12 of the prior art (FIG. 4E).

Reduced-mass seal rings 71 may be formed from a carbon-based material (e.g. carbon-graphite), ceramic, solid lubricant material, or combinations thereof. Seal rings 71 may comprise multiple materials.

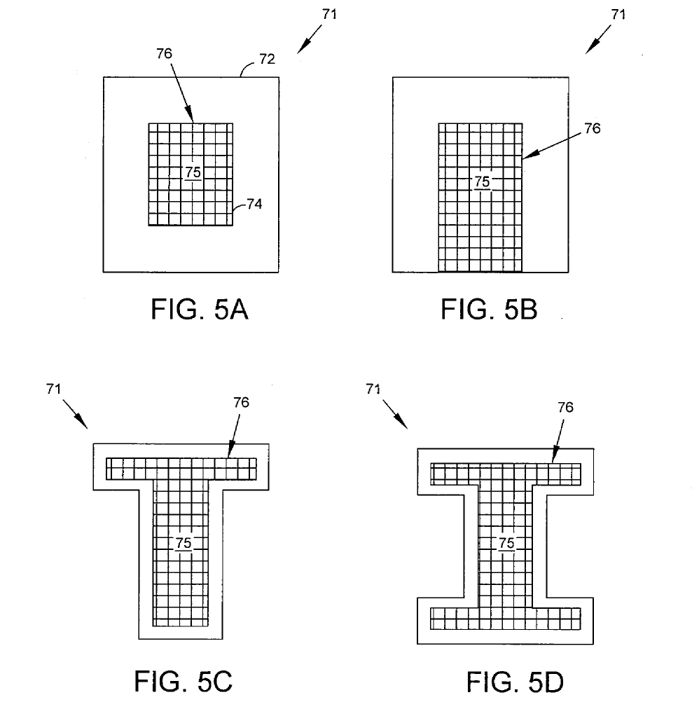

In some embodiments the reduced-mass seal ring 71 may comprise an interior honeycomb 76 within one or more interior channels 75 of the seal ring 71. FIGS. 5A through 5D illustrate such embodiments. In FIG. 5A, a seal ring 71 having an O-shaped cross section comprises an interior honeycomb 76 within the interior channel 75 bounded by the interior surface 74. In FIG. 5B, a seal ring 71 having a U-shaped cross section comprises an interior honeycomb 76 within the interior channel 75. In FIG. 5C, a seal ring 71 having a T-shaped cross section comprises an interior honeycomb 76 within an interior channel 75. In FIG. 5D, a seal ring 71 having an I-shaped cross section comprises an interior honeycomb 76 within the interior channel 75.

In some embodiments the interior honeycomb 76 and/or regions of the seal ring 71 bounding the interior channel 75 may comprise a first material and the other portions of the seal ring 71 may comprise a second material. For example, in some embodiments the interior honeycomb 76 may comprise ceramic material, while other portions of the seal ring 71 may comprise a carbon-based material. In some embodiments the region bounding the interior channel 75 and/or the interior honeycomb 76 may comprise ceramic material, while other portions of the seal ring 71 may comprise a carbon-based material. In other embodiments the interior honeycomb 76 and seal ring 71 may be formed from a common material.

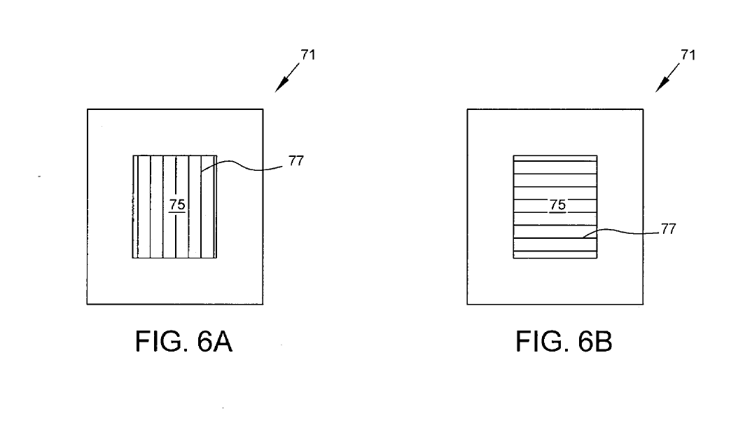

In some embodiments, the interior channels 75 of a reduced-mass seal ring 71 may have ribs 77 or similar reinforcing structures extending therethrough. FIGS. 6A and 6B illustrate two such embodiments in seal rings 71 having an O-shaped cross-section. Ribs 77 or similar reinforcing structures may extend through the interior channel 75 regardless of the cross-sectional shape of the seal ring 71. Ribs 77 or similar reinforcing structures may extend in any direction, to include axial, radial, circumferential, or at an angle to any of those directions. Ribs 77 may take one of numerous forms, to include rod- or planar-type ribs. Ribs 77 may be linear or curved.

In FIG. 6A, a seal ring 71 having an O-shaped cross section includes linear ribs 77 extending through an interior channel 75 in an axial direction. In FIG. 6B, a seal ring 71 having an O-shaped cross section includes linear ribs 77 extending through an interior channel 75 in a radial direction.

In some embodiments the ribs 77 and/or regions of the seal ring 71 bounding the interior channel 75 may comprise a first material and the other portions of the seal ring 71 may comprise a second material. For example, in some embodiments the ribs 77 may comprise ceramic material, while other portions of the seal ring 71 may comprise a carbon-based material. In some embodiments the region of the seal ring 71 bounding the interior channel 75 and/or the ribs 77 may comprise ceramic material, while other portions of the seal ring 71 may comprise a carbon-based material. In other embodiments the ribs 77 and seal ring 71 may be formed from a common material.

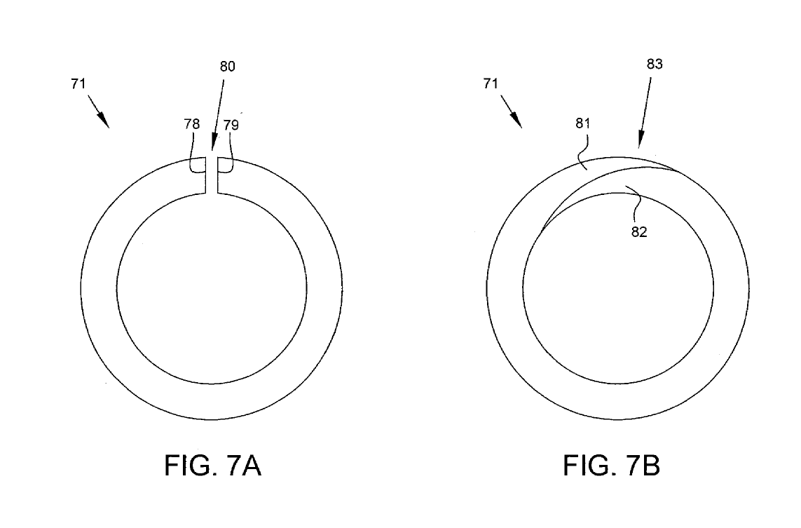

Seal rings 71 are typically not formed as a continuous ring. To form an annular ring, seal rings 71 may be joined at the ends. Reduced-mass seal ring 71 may be joined in a butt joint or a lap joint. FIGS. 7A and 7B provide axial profile views of such embodiments.

As shown in FIG. 7A, a first end 78 of the seal ring 71 may be joined to a second end 79 of the seal ring 71 at a butt joint 80. The gap between first end 78 and second end 79 is exaggerated for illustrative purposes. When installed, first end 78 should abut second end 79. During operation, under the influence of centrifugal forces the first end 78 and second end 79 may slightly separate.

As shown in FIG. 7B, in some embodiments a reduced-mass seal ring 71 comprises a first tapered end 81 and second tapered end 82 that are joined with a lap joint 83. The lap joint 83 comprises a region wherein first taper end 81 overlaps with second tapered end 82. In such an embodiment, during operation and under the influence of centrifugal forces the first tapered end 81 and second tapered end 82 are unlikely to separate, thus improving the seal between high pressure fluid cavity 30 and lower pressure fluid cavity 32.

The joining shown in FIG. 7A and 7B are applicable to all embodiments regardless of the shape of the cross section or interior channels.

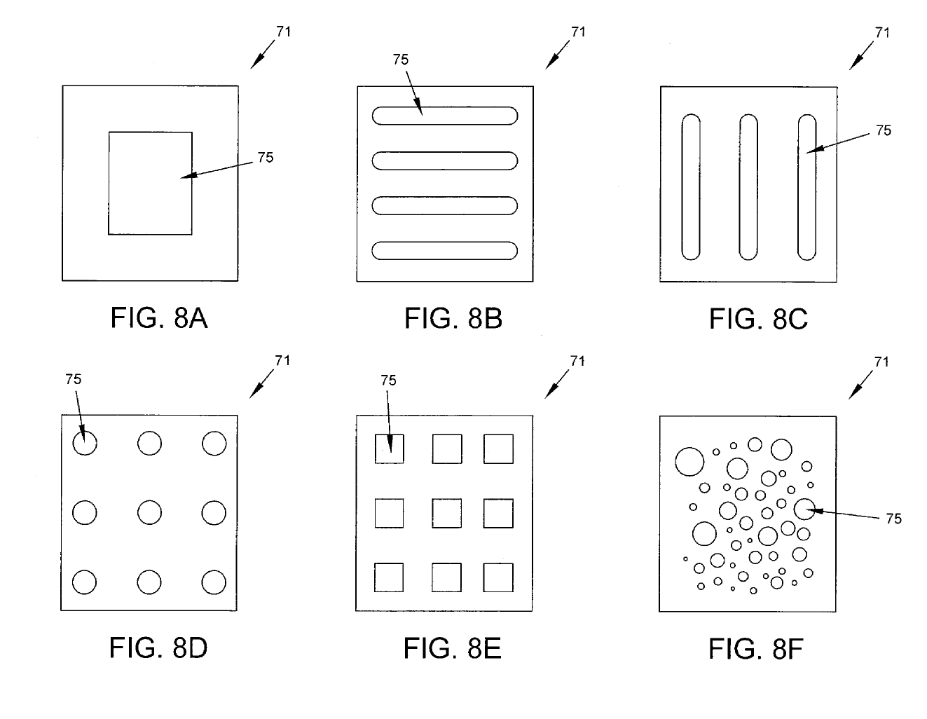

The interior channels 75 formed in the reduced-mass seal ring 71 may take many forms. Some of those forms are presented in FIGS. 8A-8F as non-limiting examples. Each of the cross-sectional views of these figures are taken at a point along the circumference of the seal ring 71.

As illustrated in FIG. 8A, in some embodiments a single interior channel 75 may have a generally rectangular, quadrilateral, elliptical, or circular cross-section, resulting in a seal ring 71 having an O-shaped cross-section.

As illustrated in FIGS. 8B and 8C, in some embodiments a seal ring 71 having a generally rectangular cross-section may have one or more interior channels 75 having an elongate elliptical cross-section. Those interior channels 75 with elongate elliptical cross-sections may be aligned axially (FIG. 8B), radially (FIG. 8C), or at an angle relative to the axial or radial direction. The interior channels 75 of FIGS. 8B and 8C may be of a uniform or non-uniform size.

As illustrated in FIG. 8D, in some embodiments a seal ring 71 having a generally rectangular cross-section may have one or more interior channels 75 having a circular cross-section. Those interior channels 75 may be aligned in a grid pattern through the seal ring 71 cross section and may be generally evenly spaced apart from each other. The interior channels 75 of FIG. 8D may be of a uniform or non-uniform size.

As illustrated in FIG. 8E, in some embodiments a seal ring 71 having a generally rectangular cross-section may have one or more interior channels 75 having a rectangular, square, rhombus, or quadrilateral shape cross-section. Those interior channels 75 may be generally evenly spaced in a grid or lattice pattern through the seal ring 71 cross section. The interior channels 75 of FIG. 8E may be of a uniform or non-uniform size.

As illustrated in FIG. 8F, in some embodiments a seal ring 71 having a generally rectangular cross-section may have one or more interior channels 75 having circular, oval, or elliptical cross sections. Those interior channels 75 may be non-uniformly sized and non-uniformly distributed through the seal ring 71 cross section, consistent with an aerated material composition such as aerogel.

Although the various shapes, dimensions, and distributions of interior channels 75 are shown in FIGS. 8A-8F in seal rings having a rectangular cross-section for illustrative purposes, the illustrated interior channels 75 may be utilized on seal rings 71 having any cross-section, including the aforementioned U-, T-, and I-shaped cross-sections.

The interior channels 75 disclosed herein may extend the full arcuate length of the seal ring 71, including through a first end 78 and second end 79 of the seal ring 71. Alternatively, the interior channels 75 may extend nearly the full length of the seal ring 71 but terminate proximate the first end 78 and second end 79 such that the seal ring 71 comprises continuous end surfaces.

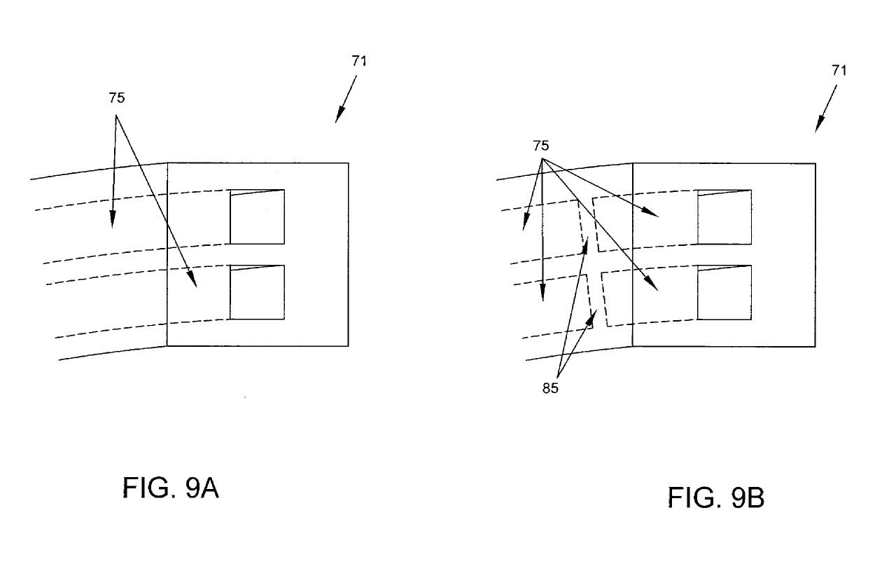

In some embodiments the interior channels 75 may extend only partially through the seal ring 71, while in other embodiments the interior channels 75 may be circumferentially segmented, having multiple similarly shaped interior channels 75 separated by radial spacers 85. FIGS. 9A and 9B are emblematic of such embodiments.

FIG. 9A presents a partial isometric view of a reduced-mass seal ring 71 having a pair of interior channels 75 extending arcuately through the entire length of the seal ring 71. FIG. 9B presents a partial isometric view of a reduced-mass seal ring 71 having interior channels 75 extending arcuately through a portion of the seal ring 71, and having radial spacers 85 disposed between interior channels 75.

In some embodiments the exterior surface 72 of a reduced-mass seal ring 71 may be coated with a lubricious coating comprising one or more of the following materials: graphite, carbon-graphite, molybdenum disulphate, boron nitride, PTFE, and similar friction-reducing materials and compounds. Lubricious coating 41 may be applied to seal ring 71 by thermal spray, PVD, CVD, painting, or similar application means.

The present disclosure further provides a method of sealing a high pressure fluid cavity from a low pressure fluid cavity. The cavities are at least partially disposed between a hollow rotating shaft and a co-axial rotating shaft at least partially disposed within the hollow rotating shaft. The method of the present disclosure comprises rotating the co-axial rotating shaft that carries a pair of annular axially-spaced runners and an annular seal ring disposed axially between the runners to effect engagement of a radially-outward facing surface of the annular seal ring with a surface of the hollow rotating shaft. The annular seal ring has an axial dimension and a radial dimension, and a cross-sectional area at any point along the circumference of the annular seal ring is less than the product of the axial dimension multiplied by the radial dimension of the annular seal ring at that point along the circumference.

Although the disclosed reduced friction intershaft seal assembly 100 is discussed with reference to a two-shaft turbine engine, one of skill in the art would understand that applications of the disclosed assembly 100 are not so limited. For example, the disclosed assembly 100 can be applied to turbine engines having multiple stages and multiple (three or more) shafts. The disclosed assembly 100 can be used to isolate high and low pressure spaces between each set of shafts.

The present disclosure is advantageous over prior art intershaft seal assemblies. A reduction in the mass of the seal ring results in less force acting between the seal ring and the sealing surfaces that it contacts during operation. This reduces friction between the various surfaces, resulting in less heat generation and reduced wear rates. Maintenance may be performed less frequently on the seal assembly, failure of the seal assembly is less likely, and the seal ring requires replacement less frequently.

The disclosed reduced-mass or reduced apparent density seal rings seek to provide material characteristics that are not naturally occurring but may be simulated with the disclosed seal ring structures. These characteristics include high wear resistance, high strength, low friction, and low mass and/or low density.

The disclosed reduced-mass or reduced apparent density seal rings may be manufactured using conventional machining techniques such as slip casting. To manufacture a seal ring having a U-shaped cross section, a ceramic slurry could be formed to a hollow rectangular shape and fired to create a blank. The blank may then be finished by machining The disclosed reduced-mass or reduced apparent density seal rings may alternatively be manufactured by additive manufacturing. Use of this technique would allow the manufacturer to reduce mass by removing (or not adding) un-needed material while also creating features (such as honeycomb or ribs) that preserve or even enhance strength and stiffness of the seal ring.

Additive manufacturing also allows for use of multiple materials in a materially hybrid seal ring. For example, as disclosed above features adding strength or stiffness to the seal ring such as honeycomb or ribs could be manufactured using ceramic, while other areas of the seal ring may be manufactured from a carbon-based material such as carbon graphite. A solid lubricant material such as metal fluoride or disulphide may be applied to exterior surfaces.

Additive manufacturing additionally provides for manufacturing a seal ring with a lap joint as disclosed above.

The present application discloses one or more of the features recited in the appended claims and/or the following features which, alone or in any combination, may comprise patentable subject matter.

Although examples are illustrated and described herein, embodiments are nevertheless not limited to the details shown, since various modifications and structural changes may be made therein by those of ordinary skill within the scope and range of equivalents of the claims.

1. A seal assembly for sealing a high pressure fluid cavity from a low pressure fluid cavity, said cavities at least partially disposed between a hollow rotating shaft and a co-axial rotating shaft at least partially disposed within the hollow rotating shaft, the seal assembly comprising:
a pair of annular axially-spaced runners carried by an outer surface of said co-axial rotating shaft, each of said runners having an axially-facing radially-extending side surface opposing an axially-facing radially-extending side surface of the other runner; and
an annular seal ring positioned axially between said opposing side surfaces of said runners, said annular seal ring having an axial dimension and a radial dimension and having a radially-outward facing surface frictionally engaged with a surface rotating with the hollow rotating shaft;
wherein a cross-sectional area at any point along the circumference of said annular seal ring is less than the product of the axial dimension multiplied by the radial dimension of the annular seal ring at that point along the circumference.

2. The seal assembly of claim 1 wherein said cross-sectional area at any point along the circumference of said annular seal ring is one of I-, T-, O-, or U-shaped.

3. The seal assembly of claim 1 wherein said annular seal ring comprises a member joined at its ends in a butt joint.

4. The seal assembly of claim 1 wherein said annular seal ring comprises a member joined at its ends in a lap joint.

5. The seal assembly of claim 1 wherein said annular seal ring comprises an O-shape cross section having an interior honeycomb.

6. The seal assembly of claim 1 wherein said annular seal ring comprises more than one materials.

7. The seal assembly of claim 6 wherein the more than one materials are combined to form the annular seal ring by additive manufacturing.

8. The seal assembly of claim 1 wherein said annular seal ring comprises a U-shape cross section having one or more ribs extending axially from one interior side of the U to the other interior side of the U.

9. A seal assembly for sealing a high pressure fluid cavity from a low pressure fluid cavity, said cavities at least partially disposed between a hollow rotating shaft and a co-axial rotating shaft at least partially disposed within the hollow rotating shaft, the seal assembly comprising:
a pair of annular axially-spaced runners carried by an outer surface of said co-axial rotating shaft, each of said runners having an axially-facing radially-extending side surface opposing an axially-facing radially-extending side surface of the other runner; and
an annular seal ring positioned axially between said opposing side surfaces of said runners, said annular seal ring having a radially-outward facing surface frictionally engaged with a surface rotating with the hollow rotating shaft;
wherein said annular ring defines one or more interior channels extending arcuately through at least a portion of said annular ring.

10. The seal assembly of claim 9 wherein said interior channels are circumferentially segmented.

11. The seal assembly of claim 9 wherein said interior channels extend the full circumference of the seal ring.

12. The seal assembly of claim 9 wherein portions of the seal ring bounding said one or more interior channels comprise a first material and externally-facing portions of the seal ring comprise a second material.

13. The seal assembly of claim 12 wherein said first material is ceramic.

14. The seal assembly of claim 13 wherein said second material is carbon graphite.

15. The seal assembly of claim 12 wherein said first material and said second material are joined to form the annular seal ring by additive manufacturing.

16. The seal assembly of claim 9 wherein said annular seal ring comprises an O-shaped cross section at any point along the circumference of said annular seal ring.

17. The seal assembly of claim 16 wherein said annular seal ring further comprises one or more reinforcing ribs extending through the hollow portion of the O-shaped cross-section.

18. A method for sealing a high pressure fluid cavity from a low pressure fluid cavity, said cavities at least partially disposed between a hollow rotating shaft and a co-axial rotating shaft at least partially disposed within the hollow rotating shaft, the method comprising:
rotating the co-axial rotating shaft that carries a pair of annular axially-spaced runners and an annular seal ring disposed axially between the runners to effect engagement of a radially-outward facing surface of the annular seal ring with a surface of the hollow rotating shaft;
wherein said annular seal ring has an axial dimension and a radial dimension, and wherein a cross-sectional area at any point along the circumference of said annular seal ring is less than the product of the axial dimension multiplied by the radial dimension of the annular seal ring at that point along the circumference.

19. The method of claim 18 wherein the co-axial rotating shaft is rotated in a first rotational direction and the hollow shaft is rotated in a second rotational direction.

20. The method of claim 18 wherein the co-axial rotating shaft and the hollow shaft are rotated in the same rotational direction.
